(19) United States
(12) Patent Application Publication
(10) Pub. No.: US 2006/0175449 A1
(43) Pub. Date: Aug. 10, 2006

(54) Anti-backlash apparatus of bait reel

(75) Inventor: Kwang Ho Hyun, Buchun-city (KR)

Correspondence Address: ST. ONGE STEWARD JOHNSTON & REENS, LLC, 986 BEDFORD STREET, STAMFORD, CT, 06905-5619, US

(73) Assignee: Doyo Engineering Co., Ltd.

(21) Appl. No.: 11/215,275

(22) Filed: Aug. 30, 2005

(30) Foreign Application Priority Data
Feb. 1, 2005 (KR) 20-2005-0002987
Feb. 1, 2005 (KR) 20-2005-0002988

(51) Int. Cl. A01K 89/02

(52) U.S. Cl. 242/286

(57) ABSTRACT

An anti-backlash apparatus of a bait reel is provided. A braking ring has a step shaped inner friction surface having a step, which is controlled in number depending on its function, and a dial with a cam is adjusted at the external of a side cover such that the braking ring stepwise moves in an axial direction and stepwise approaches a shoe holder, which is integrated with a spool, to be frictionized with the shoe, thereby minutely adjusting a brake force.

### BACKGROUND OF THE INVENTION

This application claims priority of Korean Patent Application Nos. 20-2005-0002987 and 20-2005-0002988 filed on Feb. 1, 2005.

1. Field of the Invention

The present invention relates to a spool anti-backlash apparatus of a bait reel for fishing, and more particularly, to an anti-backlash apparatus of a bait reel, for not only preventing a spool backlash but also adjusting a braking ring with a dial at the external of a side cover to stepwise adjust a friction with a shoe, and simply controlling the activation shoe in number to smoothly and minutely brake the rotation of a spool, thereby ideally controlling backlash.

2. Description of the Related Art

As well known in the art, a conventional centrifugal type brake adjusts a braking ring with a dial at the external of a side cover to cause a friction with a shoe, but has a drawback in that a braking force is not only uniformly fixed in its manufacture, thereby causing inconvenience in use, but also the shoe cannot be arbitrarily controlled in number, thereby causing a difficulty in minutely adjusting the braking force.

### SUMMARY OF THE INVENTION

Accordingly, the present invention is directed to an anti-backlash apparatus of a bait reel that substantially overcomes one or more of the limitations and disadvantages of the conventional art.

An object of the present invention is to provide an anti-backlash apparatus of a bait reel, for adjusting a braking ring with a dial at the external of a side cover, thereby stepwise adjusting a friction with a shoe.

Another object of the present invention is to provide an anti-backlash apparatus of a bait reel, for simply controlling an activation shoe in number, thereby smoothly and minutely braking the rotation of a spool and ideally controlling backlash.

A further another object of the present invention is to provide an anti-backlash apparatus of a bait reel, for stepwise adjusting a friction with a shoe and minutely braking the rotation of a spool.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided an anti-backlash apparatus of a bait reel wherein a braking ring has a step shaped inner friction surface having a step, which is controlled in number depending on its function, and wherein a dial with a cam is adjusted at the external of a side cover such that the braking ring stepwise moves in an axial direction and stepwise approaches a shoe holder, which is integrated with a spool, to be frictionized with the shoe, thereby minutely adjusting a brake force.

It is to be understood that both the foregoing general description and the following detailed description of the present invention are exemplary and explanatory and are intended to provide further explanation of the invention as claimed.

### BRIEF DESCRIPTION OF DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of an anti-backlash apparatus of a bait reel according to an embodiment of the present invention;

FIG. 2 is a section view illustrating the anti-backlash apparatus of FIG. 1;

FIG. 3 illustrates an activation state of a braking ring in the anti-backlash apparatus of FIG. 2;

FIG. 4A to 4C illustrate main steps of an activation state of the anti-backlash apparatus of FIG. 1;

FIG. 5 illustrates a construction of an anti-backlash apparatus of a bait reel according to another embodiment of the present invention;

FIG. 6 is a section view illustrating the anti-backlash apparatus of FIG. 5;

FIG. 7 illustrates an activation state of a braking ring in the anti-backlash apparatus of FIG. 6; and

FIGS. 8A to 8C illustrate main steps of an activation state of the anti-backlash apparatus of FIG. 5.

### DETAILED DESCRIPTION OF PREFERRED EMBODIMENTS

Reference will now be made in detail to the preferred embodiments of the present invention, examples of which are illustrated in the accompanying drawings. Wherever possible, the same reference numerals will be used throughout the drawings to refer to the same or like parts.

The present invention overcomes a drawback of a conventional art, and provides an anti-backlash apparatus of a bait reel, for arbitrarily controlling a brake shoe in number, and activating a dial with a cam at the external of a side cover to stepwise move a step-shaped braking ring in an axial direction, thereby arbitrarily adjusting the frictionizing shoe in number.

In the present invention, a spring is inserted, together with the shoe, into a groove of a shoe holder to enable the shoe to be always pushed inside of the shoe holder in the non-activation of a centrifugal force, thereby avoiding an unnecessary interference between the braking ring and the shoe when the shoe is moved in the axial direction. Further, the shoe is freely adjusted and placed in a position of generating or not generating a brake force, using a stop jaw provided inside of the shoe holder, thereby minutely applying the brake force to a spool.

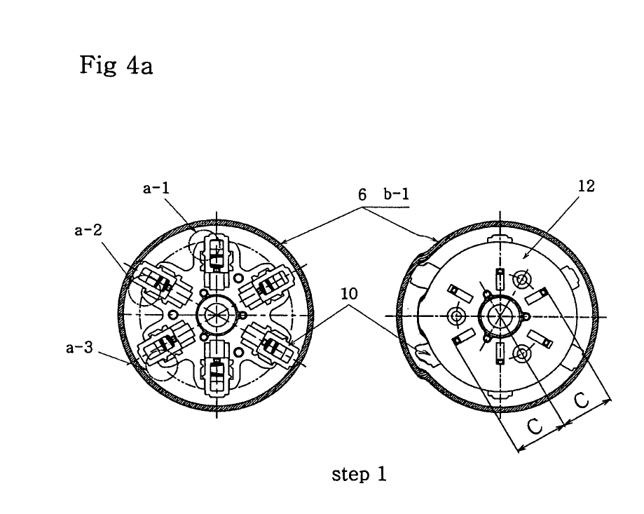

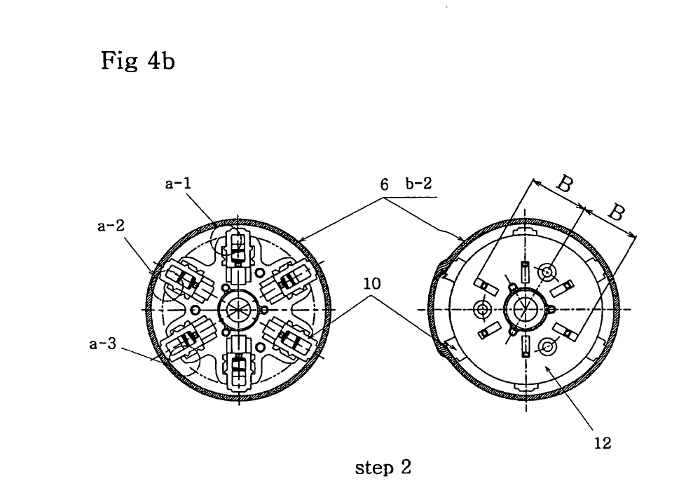

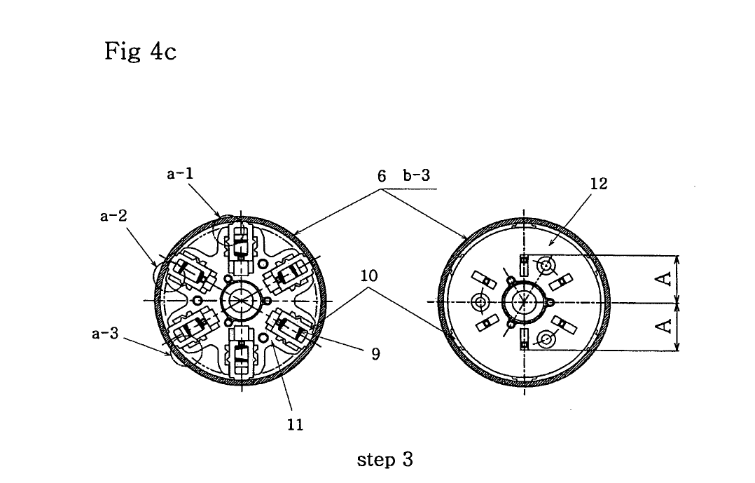

In particular, in the present invention, as shown in FIGS. 4A to 4C, a braking distance of the shoe can be segmentized into step 1 (a-2), step 2 (a-2) and (a-3), step 3 (a-1), (a-2) and (a-3) or more by varying a position of the shoe in the groove of the shoe holder. Depending on the braking distance, the braking ring can be adjusted using the dial at the external of the side cover. Further, the braking ring has a step-shaped inner surface having a step, which is controlled in number, such that the inner surface can be positioned at the braking distance of the shoe.

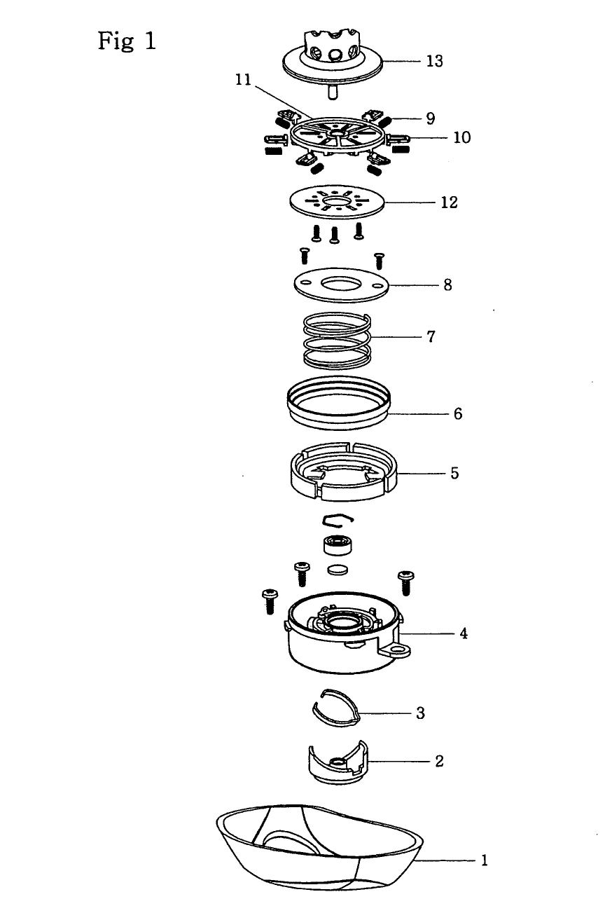

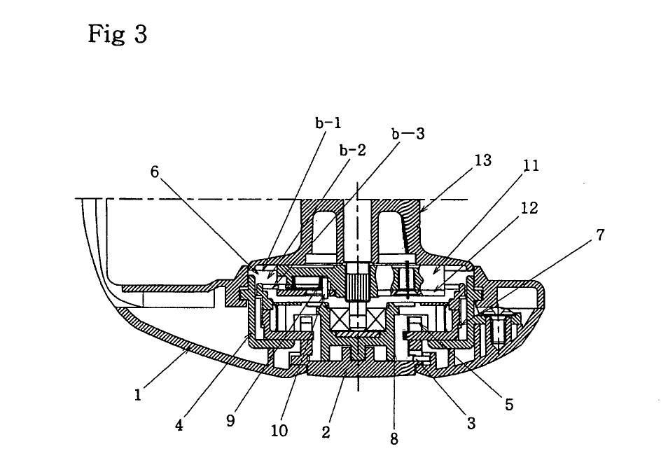

A preferred embodiment of the inventive anti-backlash apparatus having technological spirits and features will be easily understood by a detailed description of FIGS. 1 to 4 below.

FIGS. 1 to 3 illustrate a construction of the anti-backlash apparatus of the bait reel according to an embodiment of the present invention.

Referring to FIGS. 1 to 3, a click spring 3 generating sound is assembled with the adjustable dial 2 having the cam, and the assembled adjustable dial 2 is seated into a through-hole of the side cover 1 having a convex-concave shape to generate the sound.

After the dial 2 is adapted at its rotation jaw to a stop jaw of the side cover 1, the dial 2 is covered with a spool cover 4 and fixed to the side cover 1 using screws. The braking ring 6 is adhered and integrated with the braking ring holder 5, using an adhesive. After that, a protrusion disposed inside of the spool cover 4 for a flow prevention groove and a guide is assembled into an outer groove of the braking ring holder 5. A spring 7 is placed inside of the braking ring holder 5, and is assembled to the spool cover 4 and fixed to a stop plate 8 using screws to prevent the separation of the spring 7. The shoe 10 and the spring 9 are assembled to the shoe holder 11, and then the shoe holder 11 is fixed to a closure plate 12 using screws. After that, the shoe holder 11 is pressed in the spool 13.

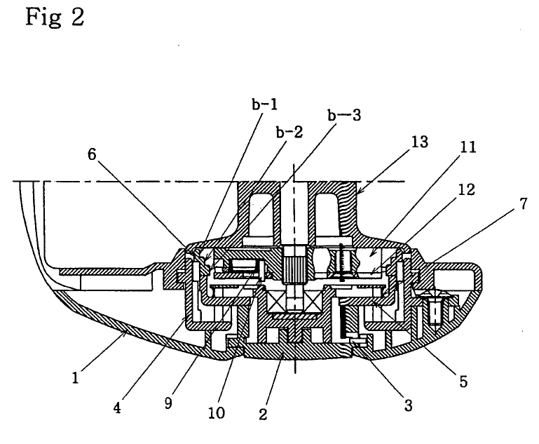

As shown in FIG. 2, the braking ring 6 has inner friction surfaces, which have small, middle and large sized diameters respectively denoted as “b-3”, “b-2”, and “b-1” to facilitate the understanding of the present invention.

FIGS. 4A to 4C illustrate a stepwise backlash control state based on three operation steps of the braking ring 6, for example.

In step 1 shown in FIG. 4A, six shoes 10 are totally provided such that two shoes 10 are paired to be in the same symmetric position with each other. The six shoes 10 are not advanced against the stop jaws (a-1), (a-2) and (a-3) disposed at ends of the grooves of the shoe holder 11. The two shoes 10 are stopped by the stop jaw (a-2) and are frictionized with the large-sized diameter (b-1) inner friction surface of the braking ring 6 to generate the brake force. The remaining four shoes 10 are spaced apart from the inner friction surfaces of the braking ring 6 by the stop jaw of the shoe holder 11. The protrusion of the shoe 10 is exteriorly protruded through a groove of the closure plate 12 such that a user can push and freely adjust the shoe 10 outward of the closure plate 12 with his/her finger. Here, the groove of the closure plate 12 has the same position as the shoe 10.

In step 2 shown in FIG. 4B, the step shaped braking ring 6 is one-step advanced toward the spool 13 such that a total of four shoes 10 (a-2) and (a-3), including the shoe 10 (a-2) of the step 1, is frictionized with the middle sized diameter (b-2) inner friction surface of the braking ring 6, thereby generating the brake force.

In step 3 shown in FIG. 4C, the step shaped braking ring 6 is one-step advanced toward the spool 13 such that a total of six shoes 10 (a-1), (a-2) and (a-3), including the shoes 10 (a-2) and (a-3) of the step 2, is all frictionized with the middle sized diameter (b-3) inner friction surface of the braking ring 6, thereby generating the brake force. Here, the protrusion of the shoe 10 protruded outside of the closure plate 12 is stepwise changed in position and therefore, the groove of the closure plate 12 is also changed in position by associating the moving distance of the shoe 10 with a distance (C) of the step 1, a distance (B) of the step 2, and a distance (A) of the step 3.

A use example of the stepwise adjustable shoe 10 is shown in Table 1.

TABLE 1

| Number of adjustable | | | | |
|---|---|---|---|---|
| shoe | Step 0 | Step 1 | Step 2 | Step 3 |
| 1 | — | ◯ | ◯ | ◯ |
| 2 | — | ◯ | ◯ | ◯ |
| 3 | — | — | ◯ | ◯ |
| 4 | — | — | ◯ | ◯ |
| 5 | — | — | — | ◯ |
| 6 | — | — | — | ◯ |

As shown in the Table 1, the shoe 10 can be adjusted with the dial through three steps, but the user can arbitrarily adjust the shoe 10 in number and segmentize the braking distance of the shoe 10 into a total of 12 steps through the steps 0 to 3, thereby effectively controlling the spool 13.

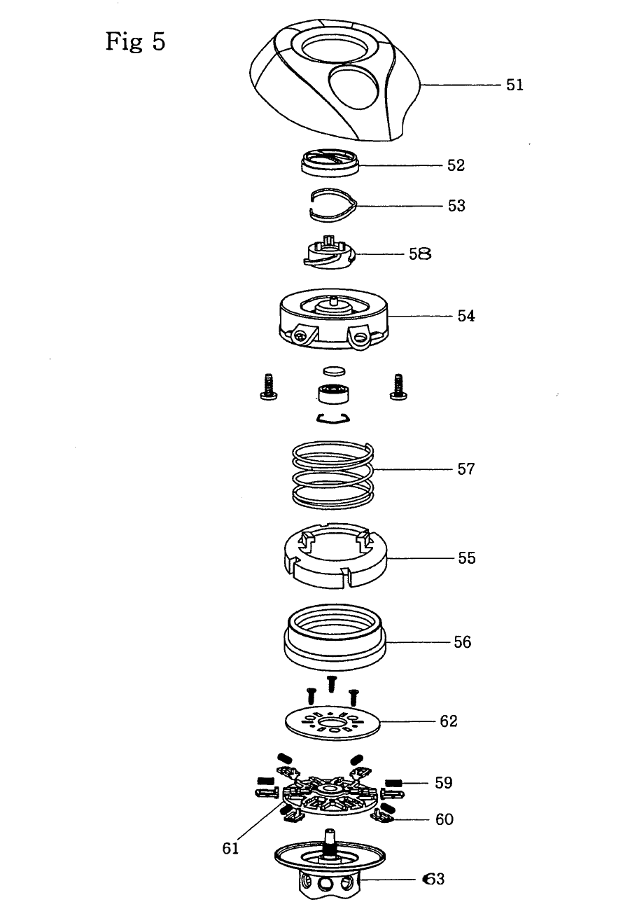

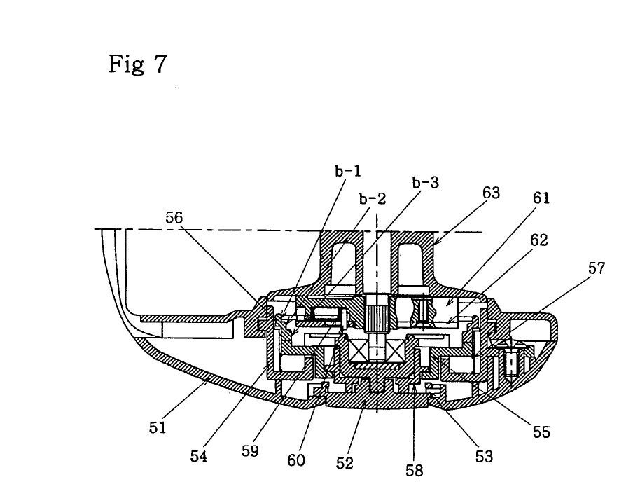

In another embodiment shown in FIGS. 5 to 8, the present invention overcomes a drawback of a conventional art, and provides an anti-backlash apparatus of a bait reel, for arbitrarily adjusting a brake shoe 60 in number, and activating a dial 52 with a cam at the external of a side cover 51 to stepwise move a step-shaped braking ring 56 in an axial direction, thereby arbitrarily adjusting the frictionizing shoe 60 in number.

A spring 59 is inserted, together with the shoe 60, into a groove of a shoe holder 61 to enable the shoe 60 to be always pushed inside of the shoe holder 61 in the non-activation of a centrifugal force, thereby avoiding an unnecessary interference between the braking ring 56 and the shoe 60 when the shoe 60 is moved in the axial direction.

Further, the shoe 60 is freely adjusted and placed in a position of generating or not generating a brake force, using a stop jaw provided inside of the shoe holder 61, thereby minutely applying the brake force to a spool 63.

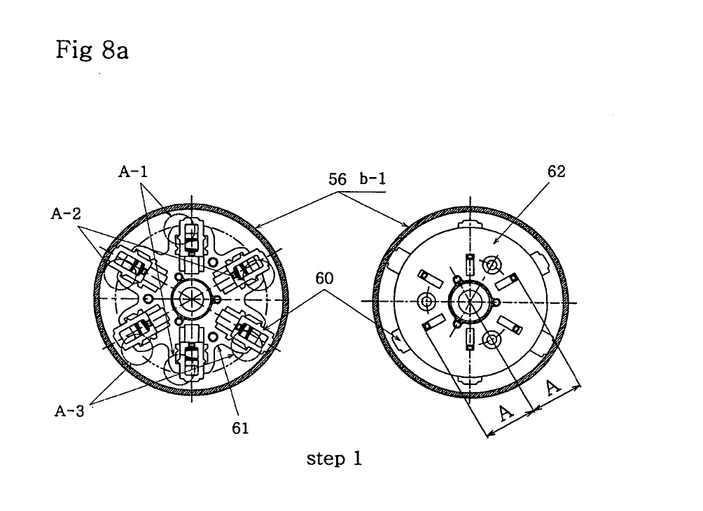

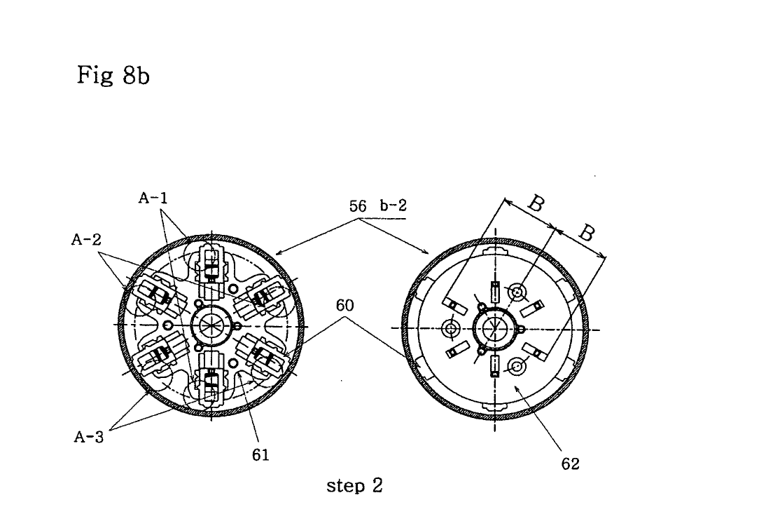

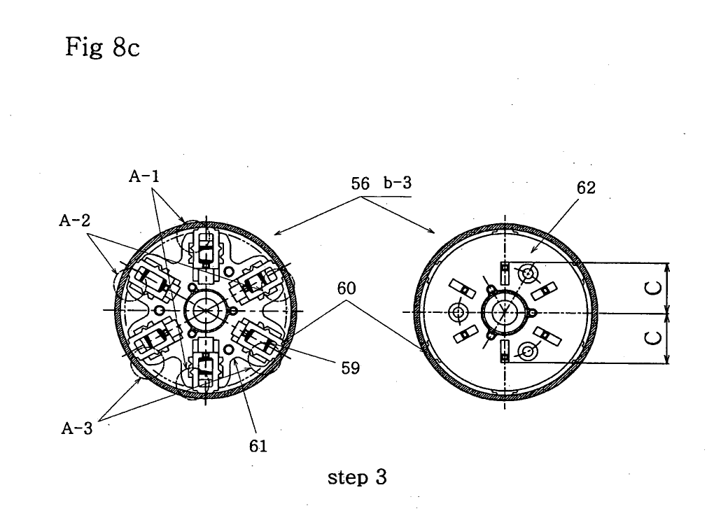

In particular, as shown in FIGS. 8A to 8C, a braking distance of the shoe 60 can be segmentized into step 1 (A-2), step 2 (A-2) and (A-3), step 3 (A-1), (A-2) and A-3) or more by varying a position of the shoe in the groove of the shoe holder 61. Depending on the braking distance, the braking ring 56 can be adjusted using the dial 52 at the external of the side cover 51. Further, the braking ring 56 is a step-shaped inner surface having a step, which is controlled in number, such that the inner surface can be positioned at the braking distance of the shoe 60.

The inventive anti-backlash apparatus will be described in detail below.

As shown in FIGS. 5 to 7, a click spring 53 generating sound is assembled with the adjustable dial 52 having the cam, and the assembled adjustable dial 52 is seated into a through-hole of the side cover 51 having a convex-concave shape to generate the sound.

After the braking ring 56 is adhered and integrated with the braking ring holder 55 using an adhesive, a spring 57 is disposed inside of a spool cover 54. A protrusion disposed inside of the spool cover 54 for a flow prevention groove and a guide is assembled into an outer groove of the braking ring holder 55 and is pushed downward, thereby protruding the protrusion of the braking ring holder 55 outside of the spool cover 54. Here, a slide cam 58 is hooked and assembled to an inner space of a protruded rib, thereby preventing separation of the spring 57. The spool cover 54 is fixed to the side cover 51 using screws. The shoe 60 and the spring 59 are assembled to the shoe holder 61, and then the shoe holder 61 is fixed to a closure plate 62 using screws. After that, the shoe holder 61 is pressed in the spool 63.

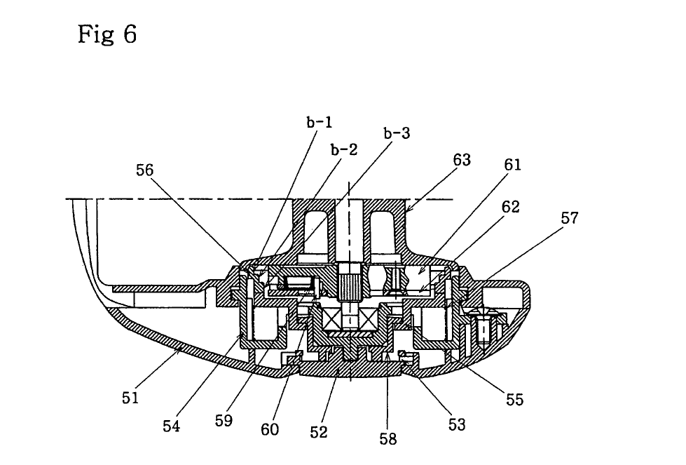

As shown in FIG. 6, the braking ring 6 has inner friction surfaces, which have small, middle and large sized diameters respectively denoted as “b-3”, “b-2”, and “b-1” to facilitate the understanding of the present invention.

FIGS. 8A to 8C illustrate a stepwise backlash control state based on three operation steps of the braking ring 6, for example.

In step 1 shown in FIG. 8A, six shoes 60 are totally provided such that two shoes 60 are paired to be in the same symmetric position with each other. The six shoes 60 are not advanced against the stop jaws (A-1), (A-2) and (A-3) disposed at ends of the grooves of the shoe holder 61. The two shoes 60 are stopped by the stop jaw (A-2) and frictionized with the large-sized diameter (b-1) inner friction surface of the braking ring 56 to generate the brake force. The remaining four shoes 60 are spaced apart from the inner friction surfaces of the braking ring 56 by the stop jaw of the shoe holder 61. The protrusion of the shoe 60 is exteriorly protruded through a groove of the closure plate 62 such that a user can push and freely adjust the shoe 60 outward of the closure plate 62 with his/her finger. Here, the groove of the closure plate 12 has the same position as the shoe 10.

In step 2 shown in FIG. 8B, the step shaped braking ring 56 is one-step advanced toward the spool 63 such that a total of four shoes 60 (A-2) and (A-3), including the shoe 60 (A-2) of the step 1, is frictionized with the middle sized diameter (b-2) inner friction surface of the braking ring 56, thereby generating the brake force.

In step 3 shown in FIG. 8C, the step shaped braking ring 56 is one-step advanced toward the spool 63 such that a total of six shoes 60 (A-1), (A-2) and (A-3), including the shoes 60 (A-2) and (A-3) of the step 2, is all frictionized with the middle sized diameter (b-3) inner friction surface of the braking ring 56, thereby generating the brake force. Here, the protrusion of the shoe 60 protruded outside of the closure plate 62 is stepwise changed in position and therefore, the groove of the closure plate 62 is also changed in position by associating the moving distance of the shoe 60 with a distance (A) of the step 1, a distance (B) of the step 2, and a distance (C) of the step 3.

A use example of the stepwise adjustable shoe 60 is shown in Table 2.

TABLE 2

| Number of adjustable | | | | |
|---|---|---|---|---|
| shoe | Step 0 | Step 1 | Step 2 | Step 3 |
| 1 | — | ◯ | ◯ | ◯ |
| 2 | — | ◯ | ◯ | ◯ |
| 3 | — | — | ◯ | ◯ |
| 4 | — | — | ◯ | ◯ |
| 5 | — | — | — | ◯ |
| 6 | — | — | — | ◯ |

As shown in the Table 2, the shoe 60 is adjusted with the dial through three steps, but the user can arbitrarily adjust the shoe 60 in number and segmentize the braking distance of the shoe 60 into a total of 12 steps through steps 0 to 3, thereby effectively controlling the spool 63.

As described above, the present invention has an advantage in that the spool backlash is not only prevented but also the braking ring is adjusted with the dial at the external of the side cover to stepwise adjust the friction with the shoe, and the activation shoe is simply controlled in number to smoothly and minutely brake the rotation of the spool, thereby ideally controlling the backlash.

It will be apparent to those skilled in the art that various modifications can be made in the present invention. Thus, it is intended that the present invention covers the modifications and variations of this invention provided they come within the scope of the appended claims and their equivalents.

What is claimed is:

1. An anti-backlash apparatus of a bait reel, wherein a braking ring has a step shaped inner friction surface having a step, which is controlled in number depending on its function, and
wherein a dial with a cam is adjusted at the external of a side cover such that the braking ring stepwise moves in an axial direction and stepwise approaches a shoe holder, which is integrated with a spool, to be frictionized with the shoe, thereby minutely adjusting a brake force.

2. The apparatus according to claim 1, wherein the shoe can be stepwise frictionized with the braking ring in a sequence of two, four, and six in number, and
wherein when the shoe is manipulated and controlled to be immovable in the shoe holder, the shoe can be arbitrarily adjusted in number and activated with an odd number as well as with an even number.

3. The apparatus according to claim 1, wherein the shoe is pushed, using a shoe controlling spring, in an opposite direction of the inner friction surface of the braking ring, thereby avoiding unnecessary interference with the shoe when the braking ring is moved in the axial direction,
wherein the shoe in a groove of the shoe holder is different in position such that when the spool is rotated using the commonly used shoe, a moving distance of the shoe 10 is determined by stop jaws, which are different in position from one another, to allow an amount of outward protrusion of the shoe to be different on the same line, and
wherein the braking ring is moved up and down of the axial direction such that the inner friction surfaces can be frictionized with the shoe whose moving distance has been determined, to stepwise adjust the brake force.

4. A spool anti-backlash apparatus of a bait reel for fishing, wherein a braking ring has a step shaped inner friction surface having a step, which is controlled in number depending on its function,
wherein a dial with a cam is adjusted at the external of a side cover such that the braking ring stepwise moves in an axial direction and stepwise approaches a shoe holder, which is integrated with a spool, to be frictionized with the shoe, thereby minutely adjusting a brake force,
wherein the shoe can be stepwise frictionized with the braking ring in a sequence of two, four, and six in number, and
wherein when the shoe is manipulated and controlled to be immovable in the shoe holder, the shoe can be arbitrarily adjusted in number and activated with an odd number as well as with an even number.

5. The apparatus according to claim 4, wherein the shoe is pushed, using a shoe controlling spring, in an opposite direction of the inner friction surface of the braking ring, thereby avoiding unnecessary interference with the shoe when the braking ring is moved in the axial direction,
wherein the shoe in a groove of the shoe holder is different in position such that when the spool is rotated using the commonly used shoe, a moving distance of the shoe is determined by stop jaws, which are different in position from one another, to allow an amount of outward protrusion of the brake shoe to be different on the same line, and
wherein the braking ring is moved up and down of the axial direction such that the inner friction surfaces can be frictionized with the shoe whose moving distance has been determined, to stepwise adjust the brake force.
